(19) United States
(12) Patent Application Publication
(10) Pub. No.: US 2026/0349125 A1
(43) Pub. Date: Nov. 5, 2026

(54) RADIATION DETECTION SYSTEMS AND METHODS

(71) Applicant: CERIUM LABORATORIES LLC, Austin, TX (US)

(72) Inventors: Dale Julson, Austin, TX (US); Timothy Hossain, Austin, TX (US); Clayton Fullwood, Austin, TX (US)

(21) Appl. No.: 19/177,531

(22) Filed: Apr. 12, 2025

Related U.S. Application Data
(60) Provisional application No. 63/633,680, filed on Apr. 12, 2024.

(51) Int. Cl. G01T 1/24

(52) U.S. Cl. CPC G01T 1/242; G01T 1/247

(57) ABSTRACT

The present disclosure provides a radiation detection device comprising a first set of conductive pads, a second set of conductive pads interlaced with the first set of conductive pads, an insulation layer separating the first set of conductive pads from the second set of conductive pads, and a read transistor electrically connected to at least one pad of the second set of conductive pads. A radiation reactive material can be disposed around the conductive pads and insulation layer. The first and second sets of conductive pads may be arranged in alternating layers formed in metal layers of a semiconductor chip. The read transistor may comprise a floating gate electrically connected to the at least one pad of the second set of conductive pads and a control gate configured to receive a control voltage for reading a charge state of the floating gate.

### CROSS-REFERENCE TO RELATED APPLICATION(S)

This application claims benefit of U.S. Provisional Application No. 63/633,680, filed Apr.12, 2024, which is incorporated herein by reference in its entirety.

### FIELD OF THE DISCLOSURE

This disclosure, in general, relates to systems and methods for detecting ionizing radiation.

### BACKGROUND

Detection of radiation is increasingly becoming of interest to society. Various forms of radiation can influence the performance of electronic circuitry. Such is the case with terrestrial electronics, and with increasing use of satellites and interest in space travel, the effect of radiation on both electronics and passengers is of increasing concern. Moreover, radiation has been used in a variety of positive applications such as medicine and tomography. However, radiation also has negative potential, such as radiation leaks into the environment and deliberate use for terrorist activities.

Terrestrially, various radiation sources can influence the performance of electronics, flipping bits resulting in erroneous calculations and programming. Once outside the protection of the atmosphere, such concerns around the effects of radiation on electronics increases significantly. Unexpected changes in data or erroneous instructions can cause poor operation or even permanent damage to orbiting satellites and may cause life-threatening malfunctions to orbiting spacecraft. To the extent that human space travel is increasing, the effect of radiation on human health is also an increasing concern.

Various forms of radiation have also been used in tomography. For example, x-rays have been used to detect structures and provide three-dimensional imaging.

With the occurrence of highly publicized terrorist events, concern for control of hazardous materials, particularly radioactive sources, is high. In particular, sources of neutron radiation are of particular concern. Fissile material can be used to make dirty bombs or nuclear weapons, which if used, could cause extensive loss of life and property damage.

In each case, the equipment conventionally used to detect radiation can be bulky or slow. Conventional methods for detecting neutron radiation suffer from sensitivity to gamma radiation and high cost. Conventional technologies for detecting neutron radiation are expensive and cumbersome. Large and expensive equipment is used at major ports to test for the presence of radioactive material. On the other extreme, smaller handheld devices with low sensitivity are available.

As such, a small form, rapid detection system would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an example radiation detection circuity.

FIG. 2 includes an illustration of an example transistor.

FIG. 3 includes a graph of an example readout response to radiation.

FIG. 4 includes an illustration of an example radiation detection circuitry.

FIG. 5 includes an illustration of an example radiation detection circuitry.

FIG. 6 includes an illustration of an example radiation detection circuitry.

FIG. 7 includes an illustration of an example radiation detection circuitry.

FIG. 8 includes an illustration of an example radiation detection circuitry.

FIG. 9 includes an illustration of an example radiation detection circuitry.

FIG. 10 includes an illustration of an example radiation detection circuitry.

FIG. 11 includes an illustration of an example radiation detection circuitry.

FIG. 12 includes a block flow diagram of an example method for detecting radiation.

FIG. 13 includes an illustration of a radiation detection system.

The use of the same reference symbols in different drawings indicates similar or identical items.

### DETAILED DESCRIPTION

In an exemplary embodiment, a radiation detection system includes an array of radiation detection devices. The devices include a first set of pads interlaced with a second set of pads to overlap with each other. The first set of pads can be electrically connected to ground or alternatively to a separate floating gate transistor or separate bias. At least one of the second set of pads is connected to the floating gate of a read transistor. The first and second set of pads are separated by a dielectric material. In an example, the dielectric material can be an oxide of silicon. In another example, the dielectric material can include a radiation reactive material. For example, when a neutron radiation interacts with the radiation reactive material, the radiation reactive material can release an alpha particle that influences charge in a pad of the second set of pads.

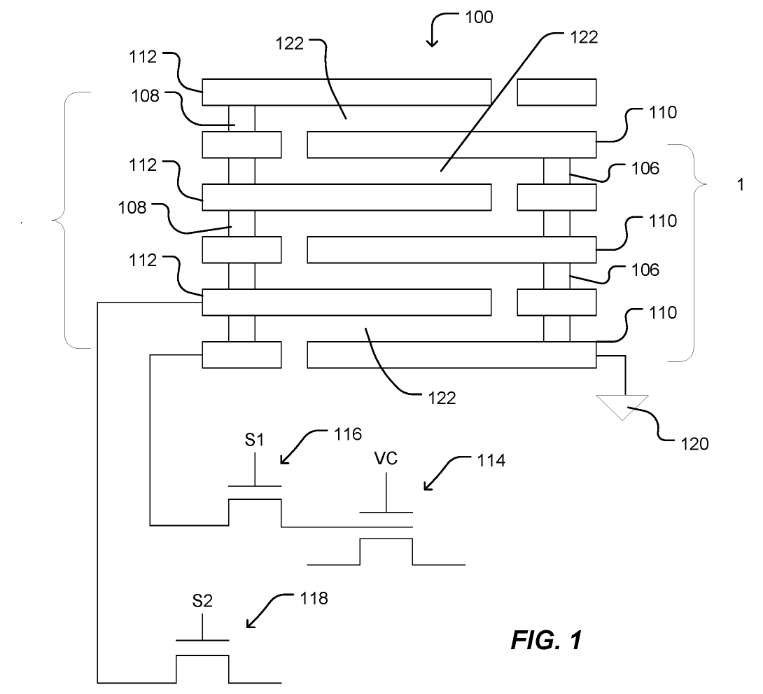

In an example, FIG. 1 illustrates a radiation detection circuitry 100. The circuitry 100 includes a first set 102 of pads 110 and a second set 104 of pads 112. The sets of pads 102 and 104 are interlaced so that pads 110 extend between pads 112 separated by insulative material. When viewed along a normal from a substrate, the pads 110 and 112 at least partially overlap similar to capacitive elements.

In an example, pads 110 and 112 can be formed in different metal layers within a semiconductor chip. In an example, the pads 110 and 112 can be formed of semiconductive or conductive material. For example, the pads 110 and 112 can be formed of polysilicon, such as doped polysilicon, or a metal, such as titanium, tantalum, tungsten, or aluminum. The pads 110 and 112 can have a thickness in a range of 10 nm to 500 nm, such as a range of 50 nm to 350 nm, or a range of 150 nm to 250 nm.

The first set 102 of pads 110 can be electrically connected together through vias 106. As illustrated, the first set 102 of pads 110 are connected to ground 120. Alternatively, the first set 102 of pads 110 can be connected to a separate floating gate transistor or can be connected to a separate bias or reference voltage. The second set 104 of pads 112 can be electrically isolated from one another. In another example, the second set 104 of pads 112 can be electrically connected using vias 108.

At least one of the pads 112 can be connected to a read circuit including a transistor 114. For example, at least one pad 112 can be electrically connected to a floating gate of the transistor 114. The transistor 114 can further include a control gate connected to a control voltage VC. Optionally, the read circuit includes a select transistor 116. The selected transistor 116 can be electrically connected between the at least one pad 112 and the read transistor 114. The at least one pad 112 can be electrically connected as a source for the selected transistor 116. In response to a select voltage S1, the transistor 116 can permit electrical communication between at least one pad 112 and the transistor 114.

The circuitry can further include a charge transistor 118. The charge transistor 118 can be electrically connected to one or more of the pads 112. At least one pad 112 can be connected to a source or a drain at the charge transistor 118. In response to the selection voltage S2, the transistor can allow charging or draining of the at least one pad 112 depending on the configuration.The circuitry can further include a charge transistor 118. The charge transistor 118 can be electrically connected to one or more of the pads 112. At least one pad 112 can be connected to a source or a drain at the charge transistor 118. In response to the selection voltage S2, the transistor can allow charging or draining of the at least one pad 112 depending on the configuration.

Depending on the nature and the system, the pads can be formed of a semiconductor or conductive material, such as polysilicon, e.g., doped polysilicon, or a metal, such as tungsten, titanium, tantalum, or aluminum. The sets of pads 102 and 104 can be electrically isolated from one another with an insulation material 122. In an example, the insulation material can be an oxide or nitride of silicon, such as an oxide of silicon.

In another example, the insulation material can be doped to react to radiation, such as reacting to neutron radiation. In an example, the insulation material can include a radiation reactive material. For example, the radiation reactive material can include an atomic composition that decomposes in response to thermal neutrons and produces an alpha particle. The radiation reactive material can include a radiation reactive component boron-10 (¹⁰B), lithium-6 (⁶Li), cadmium-113 (¹¹³Cd), gadolinium-157 (¹⁵⁷Gd), uranium-235 (²³⁵U), or a combination thereof. The radiation reactive material can be an oxide, nitride, carbide, silicide, oxynitride, or a combination thereof including the radiation reactive component. For example, the radiation reactive material can be an oxide of boron, a nitride of boron, or a carbide of boron. In a particular example, the radiation reactive material is an oxide of boron, such as B₂O₃. In a further example, the radiation reactive material is a borosilicate glass or a borophosphosilicate glass.

The radiation reactive material can include the radiation reactive component (e.g., a radiation reactive isotope of an element) along with non-radiation reactive isotopes of the element. In an example, the radiation reactive component is included in an enriched amount of at least 50%, expressed as a percentage of atoms relative to the total of all the isotopes of the related element. For example, the radiation reactive component can be included in an enriched amount of at least 70%, such as at least 80%, or even at least 90%, such as approximately 100%. In a particular example, the radiation reactive material includes boron-10 in an enriched amount of at least 50%, such as at least 70%, at least 80%, at least 90% or at least 99%.

A first set of pads can include one or more pads, such as between two and ten pads, for example, between two and eight pads, or between three and six pads. A second set of pads can include one or more pads, such as between two and ten pads, for example, between two and eight pads, or between three and six pads. In an example, the pads of the first set and the pads of the second pads are interlaced meaning disposed in different layers and at least partially overlap one another. For example, the pads of the first set of pads are distributed in different layers and the pads of the second set of pads are distributed in layers between the layers of the pads from the first set of pads and extend between and overlap the pads of the first set of pads.

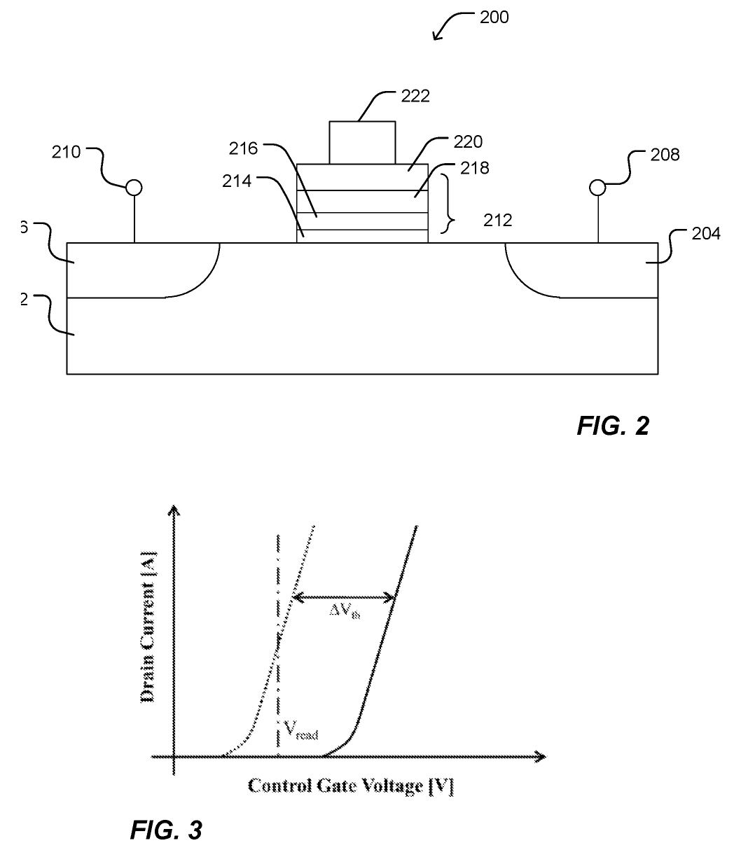

FIG. 2 includes an illustration of an example read transistor 200 including a substrate 202. In the illustrated example, the substrate 202 is a p-type substrate with n-type wells 204 and 206 coupled to source 210 or drain 208 contacts. Alternatively, the substrate can be an n-type substrate with p-type wells acting as source and drain.

A gate structure 212 is formed over the substrate 202 between the wells 204 and 206. The gate structure 212 includes a thin layer oxide 214 (tunneling dielectric), a floating gate 216 disposed over the thin layer oxide 214, an additional dielectric layer 218 disposed over the floating gate 216, and a control gate 220 disposed over the dielectric layer 218. The control gate 220 can be connected to conductor 222.

In an example, the thin oxide layer 214 can be an oxide of silicon. Alternatively, the layer can include other insulation materials. In particular, the oxide layer 214 can have a thickness in a range of 0.5 nm to 10 nm, such as a range of 1 nm to 8 nm or a range of 2 nm to 6 nm.

In an example, the floating gate 216 can be formed of doped polysilicon. Alternatively, the floating gate 216 can be formed of a conductive material, such as a metal, for example, tungsten, titanium nitride, tantalum, cobalt, or aluminum. For example, the floating gate 216 can have a thickness in a range of 10 nm to 300 nm, such as a range of 50 nm to 200 nm or a range of 100 nm to 200 nm.

The insulator layer 218 can be formed of an oxide or nitride of silicon or another insulator. For example, the dielectric layer 218 can have a thickness in a range of 0.5 nm to 50 nm, such as a range of 5 nm to 40 nm or a range of 5 nm to 30 nm.

The control gate 220 can be formed of doped polysilicon or a silicide. In another example, the control gate 220 can be formed of tungsten, tantalum, titanium, titanium nitride, cobalt, or aluminum. In an example, the control gate 220 can have a thickness in a range of 10 nm to 500 nm, such as a range of 50 nm to 350 nm or a range of 150 nm to 250 nm.

The flow of electrons or current through the substrate between the source 204 and drain 206 can be influenced by charge on the floating gate 216 and charge applied to the conductor 222 and control gate 220. The charge on the floating gate 216 can be influenced by a charge on a connected pad. Electrons trapped in the floating gate alter the threshold voltage of the transistor. A low voltage can be applied to the control gate. If the floating gate has no charge, the threshold voltage is low, and the transistor turns on. If the floating gate contains trapped electrons, the threshold voltage is higher, and the transistor remains off at the read voltage.

As illustrated in FIG. 3, the current response to a change in the control gate voltage changes based on a charge of the floating gate, which can be influenced by a charge on the pad. The curve illustrated in FIG. 3 plots drain current (I_{D}) on the y-axis versus control gate voltage (V_{CG}) on the x-axis. The vertical dashed line separates two key behaviors. The right side of the dashed line represents a charged floating gate. Because of the extra negative charge trapped in the floating gate, it takes more control gate voltage to turn the transistor on. This means the threshold voltage has shifted higher, and at normal read voltages, no current flows. The left side represents an uncharged floating gate. With no additional electrons repelling the control gate voltage, the threshold is lower, and current flows even at lower voltages.

A fixed read voltage (V_{READ}) is applied to the control gate. This voltage is typically set between the two threshold voltages (i.e., between charged and uncharged states). The drain current (I_{D}) is measured. If I_{D} ≈ 0, the floating gate is charged. If I_{D} > 0, the floating gate is uncharged. Alternatively, more than one read voltage can be used to determine or quantify charge on the floating gate.

Radiation influences the charge on the floating gate. Applying the read voltage and measuring the drain current can indicate a change in charge caused by the radiation. The charge on the floating gate or pad can be reset by applying a high voltage to the control gate.

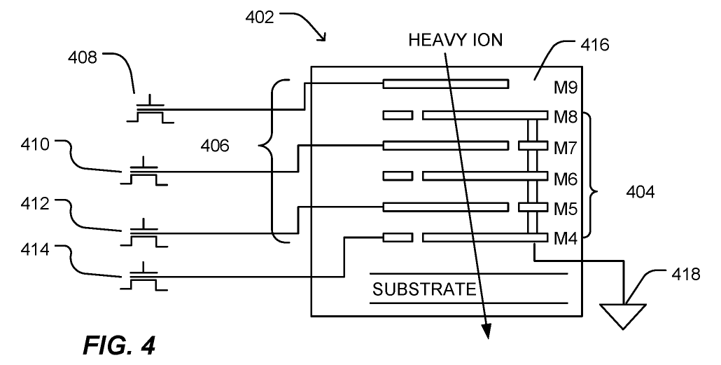

FIG. 4 includes an example circuit to detect heavy ion radiation. For example, the circuit can include a stack 402 formed of a first set of pads 404 interlaced with a second set of pads 406. The first set of pads 404 is electrically isolated from the second set of pads 406 by an insulation material 416. In an example, the insulation material 416 can be an oxide of silicon or another dielectric material, such as hafnium oxide or another high-dielectric material. The pads can be formed from a semiconductor or conductor. For example, the pads can be formed of doped polysilicon. In another example, the pads can be formed of tungsten, tantalum, titanium, titanium nitride, cobalt, or aluminum. The first set of pads 404 can be electrically connected together and connected to ground 418. Alternatively, the first set of pads 404 can be connected to a floating gate transistor or a bias or reference voltage. As illustrated, each of the pads of the second set of pads 406 is connected to the floating gate of different read transistors 408, 410, 412, or 414.

The sets of pads can include pads disposed in at least 3 layers, such as at least 4 layers. For example, the sets of pads can be interlaced and disposed in 2 to 12 layers.

In response to heavy ion radiation, radiation can pass through one or more of the pads from either set 404 or set 406, influencing the charge on the pads of set 406. When the pads of the set of pads 404 are grounded, disturbances caused by the passage of a heavy ion are mitigated by the connection to ground. Any change in charge on the pads of set 406 can be read by one or more of the read transistors 408, 410, 412 or 414.

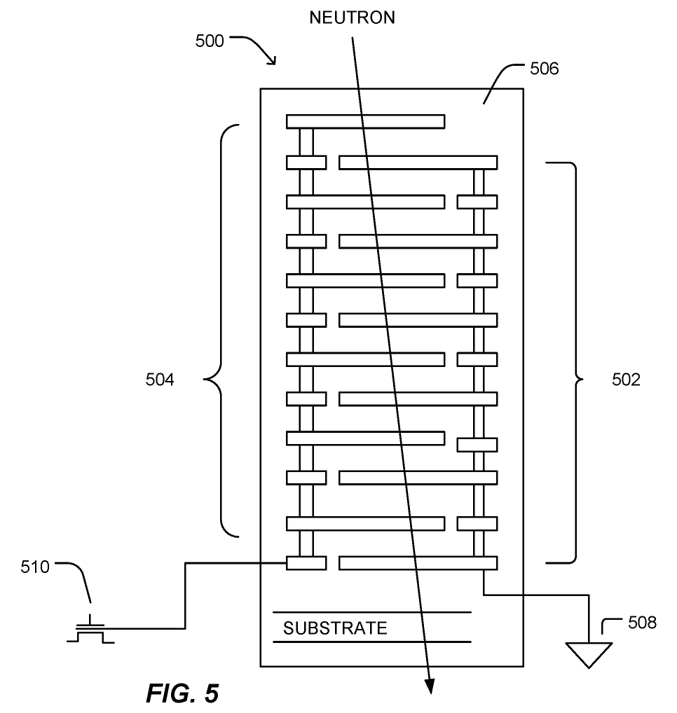

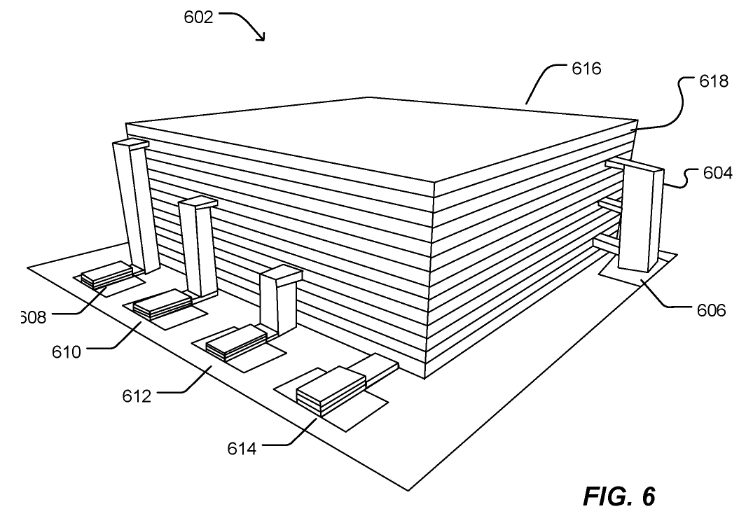

FIG. 5 includes an illustration of an example circuitry 500 for detecting neutron radiation. For example, the circuitry 500 includes a first set of pads 502 interlaced with a second set of pads 504 formed into the metal layers of a semiconductor chip. As illustrated, the first set of pads 502 are connected together with vias and connected to ground 508. Alternatively, the first set of pads 502 can be connected to a floating gate transistor or a bias or reference voltage. The second set of pads 504 are electrically connected together, such as through vias and are connected to a read transistor 510.

In an example, the pads of the first set of pads 502 or the second set of pads 504 can be formed of doped polysilicon. Alternatively, the pads can be formed of tungsten, tantalum, titanium, titanium nitride, cobalt, or aluminum. The first and second sets of pads are isolated from one another with a dielectric material 506. In an example, the dielectric material is an oxide of silicon or hafnium. In another example, the dielectric material is responsive to radiation. For example, the dielectric material 506 includes a radiation reactive material that can include an atomic composition that decomposes in response to thermal neutrons and produces an alpha particle. The radiation reactive material can include a radiation reactive component boron-10 (¹⁰B), lithium-6 (⁶Li), cadmium-113 (¹¹³Cd), gadolinium-157 (¹⁵⁷Gd), uranium-235 (²³⁵U), or a combination thereof. The radiation reactive material can be an oxide, nitride, carbide, silicide, oxynitride, or a combination thereof including the radiation reactive component. For example, the radiation reactive material can be an oxide of boron, a nitride of boron, or a carbide of boron. In a particular example, the radiation reactive material is an oxide of boron, such as B₂O₃. In a further example, the radiation reactive material is a borosilicate glass or a borophosphosilicate glass. Further, the radiation reactive component can be enriched, such as at least 10% enriched, at least 30% enriched, at least 50% enriched, or at least 80% enriched.

In an example, the passage of a neutron through the system can interact with the radiation responsive dielectric material 506 causing the emission of particles that may influence charge on the second set of pads. Change in charge can be measured using the read transistor 510. For example, a neutron can interact with boron-10 in the radiation responsive dielectric material to generate an alpha particle that can cause a change in charge on a pad if it impinges the pad.

As further illustrated in FIG. 6, a stack 602 can include alternating layers of dielectric material 616 and doped polysilicon 618. A first set of pads selected from every second polysilicon pad 618 can be connected using a polysilicon via 604 to ground 606, a separate floating gate transistor, or a bias voltage. In an example, each of the remaining pads not connected to ground can be connected to a read transistor, such as connecting to the floating gates of transistor 608, 610, 612, or 614. Alternatively, the pads of the second set of pads can be electrically connected together and connected to the floating gate of the same transistor.

The dielectric material 616 can be an inert material, such as an oxide or nitride of silicon. In another example, the dielectric material 616 can be reactive to radiation. For example, the dielectric material can include a radiation reactive material, such as those described above.

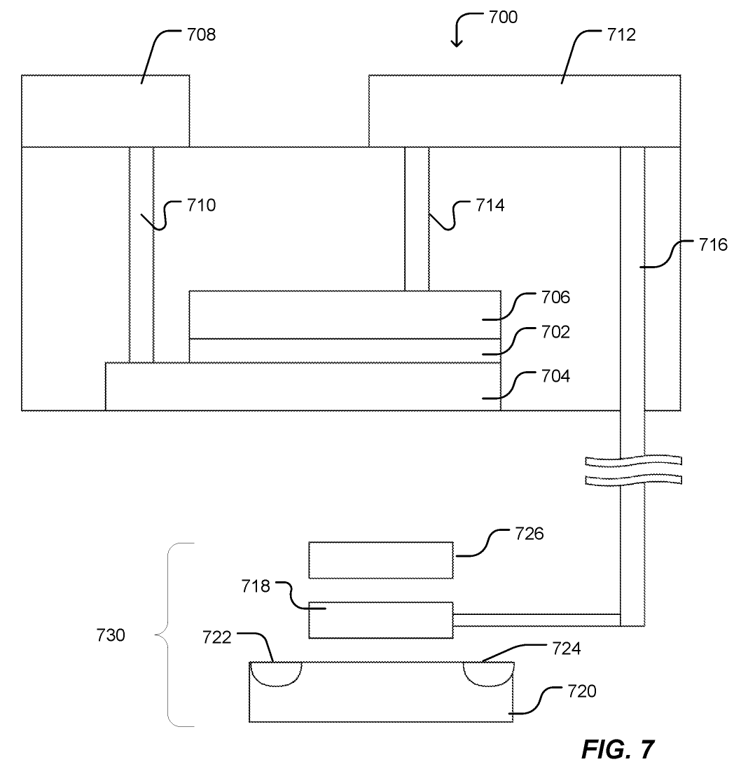

FIG. 7 illustrates another example detection circuitry 700. A dielectric layer 702 separates a lower plate 704 and an upper plate 706, forming a capacitor structure. The lower plate 704 can be connected through a via 710 to line 708. The line 708 can be connected to ground, a bias or reference voltage, or a separate transistor. The upper plate 706 or lower plate 704 can be metal, such as tungsten, tantalum, titanium, titanium nitride, cobalt, or aluminum. Alternatively, the plates can be formed of doped polysilicon.

The upper plate 706 can be connected through a via 714 to a metal line that connects to a separate via 716 in electrical communication with a floating gate 718 of a transistor 730. Alternatively, the lower metal plate 704 can be connected to the transistor 730, and the upper metal plate 706 can be connected to ground, a bias voltage, or a separate transistor.

The transistor 730 includes a source and drain (722 and 724) formed in a substrate 720. The floating gate 718 is separated from the substrate by a dielectric material. The transistor 730 further includes a control gate 726 separated from the floating gate 718 by a dielectric material.

Charge on the upper plate 706 can be measured using the transistor 730. The capacitive structure can be formed above the substrate at the level of a conventionally metal layer. The capacitive structure can be surrounded by a dielectric material 728. Optionally, the dielectric material 728 can be a radiation reactive material, as described above.

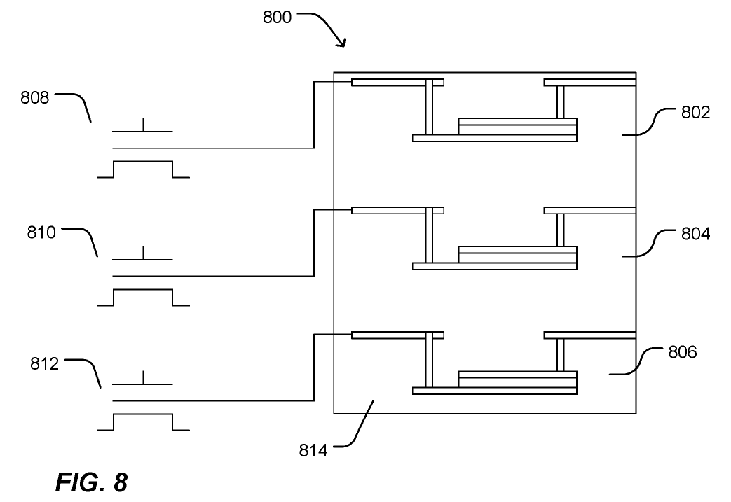

FIG. 8 includes an illustration of a stack of radiation detectors 800. Structures, such as the structure illustrated in FIG. 7, can be stacked on top of one another. For example, detectors 802, 804, and 806 can be formed over each other and each connected to a separate transistor 808, 810 or 812. In particular, one of the plates of the capacitive structure can be connected as a floating gate to a transistor.

The stack of radiation detectors 800 can be surrounded by a dielectric material 814. Optionally, the dielectric material 814 can be a radiation reactive material.

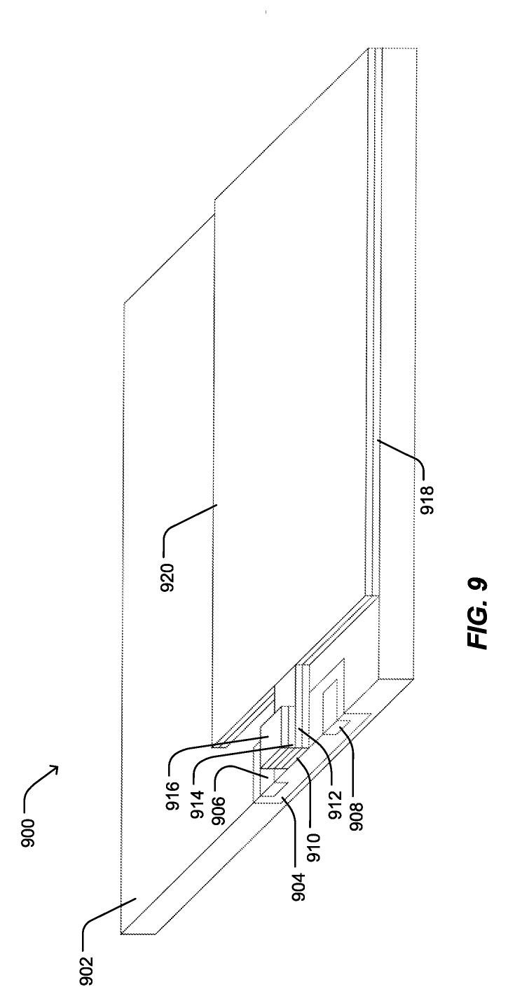

FIG. 9 includes a further illustration of a radiation detection device 900. A transistor 922 is formed in a substrate 902. The transistor includes an implant 904 and source and drain (906 and 908). The implant can be a p-type implant or an n-type implant and the source and drain formed the opposite type implant, e.g., an n-type implant or p-type implant. A gate stack is formed of a tunnel dielectric layer 910 disposed over the substrate 902. A floating gate 912 is formed over the tunnel dielectric 910. A dielectric layer 914 is formed over the floating gate 912, and the control gate 916 is formed over the dielectric layer 914.

The floating gate 912 is in electrical communication with a pad 920 formed over a dielectric material 918. The floating gate 912 and the pad 920 can be formed of polysilicon, such as doped polysilicon. In another example, the pad 920 can be formed of tungsten, tantalum, or aluminum. The pad 920 can have a thickness in a range of 10 nm to 300 nm, such as a range of 50 nm to 200 nm, or a range of 100 nm to 200 nm. The dielectric material 918 can be formed of an oxide or nitride of silicon or hafnium. In an example, the dielectric material 918 includes an oxide of silicon. The dielectric material 918 can have a thickness in a range of 0.5 nm to 50 nm, such as a range of 1 nm to 15 nm or a range of 1 nm to 10 nm.

The pad 920 can have a surface area and a range of 0.1 µm² to one 10 µm², such as a range of 0.5 µm² to 6 µm² or a range of 0.5 µm² to 2 µm². In particular, the surface area of the pad can be sized to be a multiple of the surface area of the floating gate of the transistor based on the bounds of the gate stack. For example, the surface area of the pad can be at least five times the surface area of the floating gate, such as at least 10 times, at least 20 times, at least 50 times, or at least 100 times the surface area of the floating gate. In an example, the surface area is not greater than a thousand times the surface area of the floating gate, such as not greater than 500 times or not greater than 200 times the surface area of the floating gate.

The pad 920 can store charge that is influenced by radiation. Stored charge can be detected using the transistor 922 by applying a voltage to the control gate 916. Further, the charge on the pad 920 can be reset by applying a reset voltage to the control gate 916.

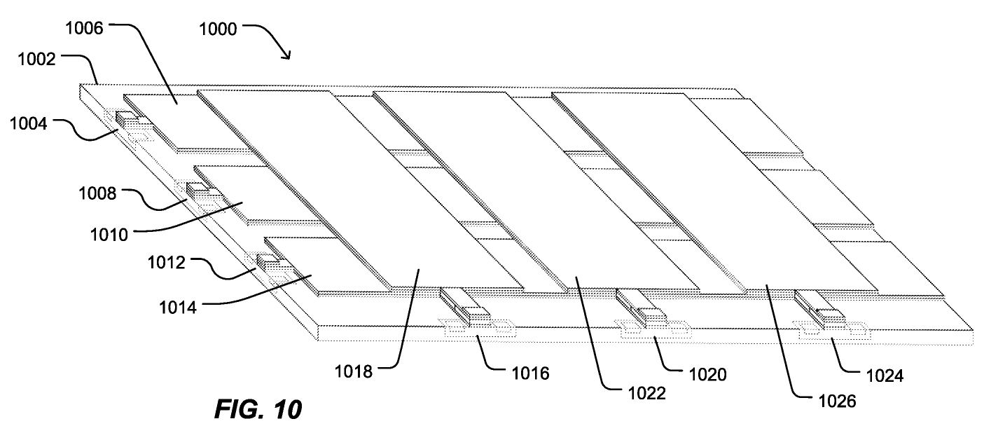

As illustrated in FIG. 10, a plurality of radiation detectors 1000 can be formed over a substrate 1002. In an example, a set of radiation detectors, each associated with a transistor, can be formed over the substrate 1002. For example, a radiation detector including a pad 1006 connected to a transistor 1004 can be formed over the substrate 1002, such as the radiation detector of FIG. 9. Additional detectors including pad 1010 connected to a transistor 1008 and pad 1014 connected to transistor 1012 can be formed over the substrate 1002. As illustrated, the pads 1006, 1008, and 1014 extend horizontally in a first direction over the substrate 1002. The pad (1006, 1008 or 1014) can function as an upper plate, and the substrate 1002 can function as an opposing lower plate of a capacitive structure. In an example, the substrate 1002 can function as ground or a reference bias.

Optionally, additional radiation detectors can be formed with pads that extend over the pads 1006, 1008, and 1014. For example, a pad 1018 connected to a transistor 1016, a pad 1022 connected to a transistor 1020, and a pad 1026 connected to a transistor 1024 extend over and optionally in a direction perpendicular to the pads 1006, 1008, and 1014. The upper pads (1018, 1022, or 1026) are separated from the lower pads (1006, 1008, and 1014) with a dielectric layer. In an example, the dielectric layer can be formed of an oxide or nitride of silicon or hafnium.

In a particular example, a first charge can be applied to the lower pads 1006, 1008 and 1014 and a different charge can be applied to the pads extending above (1018, 1022, and 1026). As such, the pads and insulator can form a capacitive structure. The charge on each of the pads can be read separately using their respective electrodes or transistors. Further, the charge on each of the pads can be reset using the respective control gates of their associated transistors.

Additional dielectric material can surround each of the pads. The dielectric material can be a radiation reactive material, such as the radiation reactive material described above.

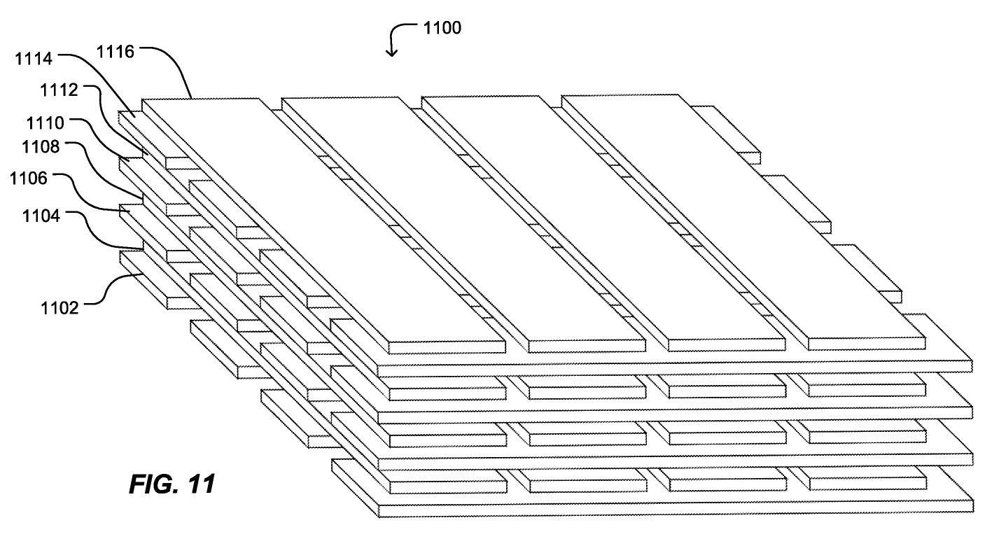

As further illustrated in FIG. 11, a stacked array 1100 of radiation detectors can be formed using various sets of detectors disposed over one another. For example, a lower layer of detectors 1102 can be formed adjacent to a substrate. A second set of detectors 1104 can be formed over the lower layer of the connectors 1102. As illustrated, the second set of detectors 1104 can be formed to extend perpendicular to the lower set of detectors 1102. Additional layers of detectors, such as detectors 1106, 1108, 1110, 1112, 1114, and 1116 can be disposed over one another and optionally each layer disposed perpendicular to the layer below it. The stacked array can include 3, 4, 6, 8 or more levels. For example, the stack can include 3 to 12 levels.

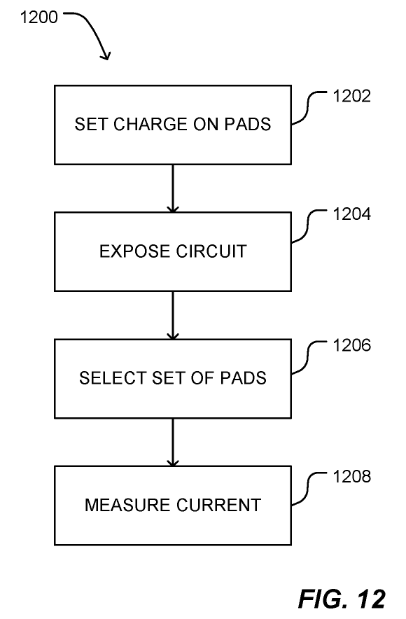

A method of operation 1200 is illustrated in FIG. 12. In example, a charge may be set on the pads, as illustrated at block 1202. In an example, one set of pads is connected to ground, while the second set of pads can optionally be connected to a charge circuitry, such as a charge transistor that can either add charge to the pads or drain charge from the pads depending on the configuration. In another example, the one set of pads can be connected to a bias or reference voltage. In a further example, the other set of pads can be connected to the floating gate of a transistor and the control gate of the transistor set to a reset voltage to add or subtract charge from the pads.

The charge may be selected based on the type of radiation to be detected. For example, ionizing radiation, such as a gamma rays, x-rays, and energetic electrons, may decrease the charge on a floating gate sensor. To detect such radiation, the charge on the second set of pads can be set high and the radiation detected when the charge moves lower. In another example, alpha particles or other radiation can increase charge. As such, the initial charge on the second set of pads can be set low; detection occurs when the charge increases.

Once charge is set on the pads, the circuitry may be exposed to radiation, as illustrated at block 1204. The charge on the pads not connected to ground or a bias voltage may be altered in response to the exposure to radiation.

As illustrated at block 1206, an optional select circuitry can be used to select one or more pads. The selection of the one or more pads may connect the pads into a floating gate of a read transistor. Current or a lack of current may be measured from the read transistor, as illustrated at block 1208, indicating a change in charge on the pads, inferring the presence or absence of radiation.

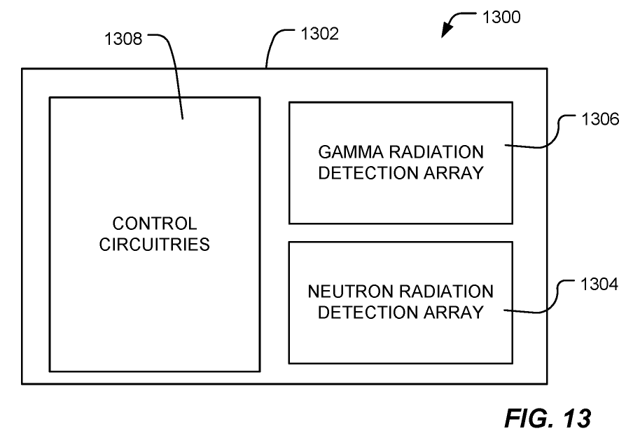

The radiation detectors can be formed into arrays that can be incorporated into a system having control circuitries, readout circuitries, and data storage. In a further example, different radiation detectors to detect different types of radiation can be incorporated into the same system. For example, as illustrated in FIG. 13, a system 1300 includes a substrate or circuit board 1302 to which a first radiation detection array 1304 is coupled and a second radiation detection array 1306 is coupled. The substrate 1302 further includes control circuitries 1308 that can control, read, and store information of the detection arrays 1304 and 1306. Optionally, the control circuitries 1308 further include input and output circuitries to permit communication with the system.

In an example, each of the detection arrays 1304 and 1306 can be formed in separate silicon substrates and attached to a common substrate 1302. In another example, the radiation detection arrays 1304 and 1306 can be formed on a common silicon substrate that further incorporates control circuitries to form a system on chip.

In an example, the radiation circuitries 1304 and 1306 can detect different types of radiation. For example, the radiation circuitry 1304 can detect neutron radiation and the radiation detector 1306 can detect ionizing radiation. In another example, the radiation detector circuitries 1304 and 1306 detect the same types of radiation.

In an example, one or more devices can be formed into an array. One or more arrays can be incorporated into a circuitry. The circuitry can be formed in the same substrate as the one or more arrays. In another example, the one or more arrays can be formed on separate substrates and stacked onto the substrate of the circuitry. The circuitry can include read-out circuitry and communications circuitry. In an addition example, the circuitry can reset the one or more arrays.

In a first aspect, a radiation detection device includes a first set of pads and a second set of pads interlaced with the first set of pads. The device further includes an insulation layer separating the first set of pads from the second set of pads, and a read transistor electrically connected to at least one pad of the second set of pads. The read transistor is operable to detect an influence of radiation on the at least one pad.

In an example of the first aspect or the examples above, the first set of pads is electrically connected to ground. In another example of the first aspect or the examples above, the first set of pads is electrically connected to a bias or reference voltage. In a further example of the first aspect or the examples above, the first set of pads is electrically connected to a second transistor.

In an additional example of the first aspect or the examples above, the insulation layer comprises a radiation reactive material. In another example of the first aspect or the examples above, the radiation reactive material comprises a component selected from the group consisting of boron-10, lithium-6, cadmium-113, gadolinium-157, and uranium-235. In a further example of the first aspect or the examples above, the component of the radiation reactive material is present in an enriched amount. In an additional example of the first aspect or the examples above, the radiation reactive material comprises an oxide of boron.

In another example of the first aspect or the examples above, the radiation detection device further includes a select transistor electrically connected between the at least one pad of the second set of pads and the read transistor. In a further example of the first aspect or the examples above, the device includes a charge transistor electrically connected to at least one pad of the second set of pads.

In an additional example of the first aspect or the examples above, the first set of pads and the second set of pads are arranged in alternating layers. In another example of the first aspect or the examples above, the first set of pads includes 2 to 10 pads disposed in separate layers. In a further example of the first aspect or the examples above, the second set of pads includes 2 to 10 pads disposed in separate layers. For example, the alternating layers are formed in metal layers of a semiconductor chip.

In another example of the first aspect or the examples above, the read transistor comprises a floating gate electrically connected to the at least one pad of the second set of conductive pads. In a further example of the first aspect or the examples above, the read transistor further comprises a control gate configured to receive a control voltage for reading a charge state of the floating gate.

In an additional example of the first aspect or the examples above, the first set of conductive pads and the second set of conductive pads are formed of polysilicon. In another example of the first aspect or the examples above, the first set of conductive pads and the second set of conductive pads have a thickness in a range of 10 nm to 500 nm. In a further example of the first aspect or the examples above, the thickness is in a range of 50 nm to 350 nm.

In an additional example of the first aspect or the examples above, a pad of the first set of pads is formed of doped polysilicon. In another example of the first aspect or the examples above, a pad of the first set of pads is formed of a metal or metal nitride.

In a second aspect, a method of detecting radiation includes providing a radiation detection device comprising a first set of pads interlaced with a second set of pads and separated by an insulation layer. The method further includes exposing the radiation detection device to radiation, and measuring a current through a read transistor electrically connected to at least one pad of the second set of pads.

In an example of the second aspect or the examples above, the read transistor is connected to all pads of the second set of pads. In another example of the second aspect or the examples above, the method further includes setting an initial charge on the second set of pads prior to exposing the radiation detection device to radiation. In a further example of the second aspect or the examples above, setting the initial charge comprises applying a voltage to a charge transistor electrically connected to the second set of pads.

In an additional example of the second aspect or the examples above, the method further includes selecting at least one pad from the second set of pads prior to measuring. For example, selecting the at least one pad comprises activating a select transistor electrically connected between the selected pad and the read transistor.

In another example of the second aspect or the examples above, measuring the current comprises applying a read voltage to a control gate of the read transistor. In a further example of the second aspect or the examples above, the read transistor comprises a floating gate electrically connected to the at least one pad. In an additional example of the second aspect or the examples above, the method further comprises resetting the charge on the floating gate by applying a reset voltage to the control gate.

In another example of the second aspect or the examples above, the insulation layer comprises a radiation reactive material. In a further example of the second aspect or the examples above, the radiation reactive material comprises a component selected from the group consisting of boron-10, lithium-6, cadmium-113, gadolinium-157, and uranium-235. In an additional example of the second aspect or the examples above, the radiation reactive material comprises an oxide of boron.

In another example of the second aspect or the examples above, the first set of pads is electrically connected to ground. In a further example of the second aspect or the examples above, the first set of pads is electrically connected to a bias or reference voltage. In an additional example of the second aspect or the examples above, the first set of pads is electrically connected to a second transistor.

In another example of the second aspect or the examples above, the first set of pads and the second set of pads are arranged in alternating layers. In a further example of the second aspect or the examples above, the alternating layers are formed in metal layers of a semiconductor chip. In an additional example of the second aspect or the examples above, the first set of pads includes 2 to 10 pads disposed in separate layers. In another example of the second aspect or the examples above, the second set of pads includes 2 to 10 pads disposed in separate layers.

In a further example of the second aspect or the examples above, the first set of pads and the second set of pads are formed of doped polysilicon. In an additional example of the second aspect or the examples above, the first set of pads and the second set of pads are formed of metal or metal nitride. In another example of the second aspect or the examples above, the first set of conductive pads and the second set of conductive pads have a thickness in a range of 50 nm to 350 nm.

In a third aspect, a stacked radiation detector array includes a plurality of detector layers arranged in a vertical stack and surrounded by an insulation material. Each detector layer includes a first set of pads and a second set of pads interlaced with the first set of conductive pads. A dielectric layer separates the first set of pads from the second set of pads, and a read transistor is electrically connected to at least one pad of the second set of pads.

In an example of the third aspect or the examples above, the first set of pads in each detector layer is electrically connected to ground. In another example of the third aspect or the examples above, the first set of pads in each detector layer is electrically connected to a bias or reference voltage. In a further example of the third aspect or the examples above, the first set of pads in each detector layer is electrically connected to a second transistor.

In an additional example of the third aspect or the examples above, the insulation material comprises a radiation reactive material. In another example of the third aspect or the examples above, the radiation reactive material comprises a component selected from the group consisting of boron-10, lithium-6, cadmium-113, gadolinium-157, and uranium-235. In a further example of the third aspect or the examples above, the component is present in an enriched amount. In an additional example of the third aspect or the examples above, the radiation reactive material comprises an oxide of boron.

In another example of the third aspect or the examples above, each detector layer further comprises a select transistor electrically connected between the at least one pad of the second set of pads and the read transistor. In a further example of the third aspect or the examples above, each detector layer further comprises a charge transistor electrically connected to at least one pad of the second set of pads. For example, the vertical stack is formed in metal layers of a semiconductor chip.

In an additional example of the third aspect or the examples above, the read transistor in each detector layer comprises a floating gate electrically connected to the at least one pad of the second set of pads. In another example of the third aspect or the examples above, the read transistor in each detector layer further comprises a control gate configured to receive a control voltage for reading a charge state of the floating gate.

In a fourth aspect, a radiation detection system includes a substrate and a plurality of radiation detection devices formed on the substrate. Each radiation detection device comprises a first set of conductive pads, a second set of conductive pads interlaced with the first set of conductive pads, and an insulation layer separating the first set of conductive pads from the second set of conductive pads. Each radiation detection device further includes a read transistor electrically connected to at least one pad of the second set of conductive pads. The system also includes readout circuitry electrically connected to the read transistors of the plurality of radiation detection devices.

In an example of the fourth aspect or the examples above, the insulation layer in each radiation detection device comprises a radiation reactive material. In another example of the fourth aspect or the examples above, the radiation reactive material comprises a component selected from the group consisting of boron-10, lithium-6, cadmium-113, gadolinium-157, and uranium-235. In a further example of the fourth aspect or the examples above, the radiation reactive material comprises an oxide of boron.

In an additional example of the fourth aspect or the examples above, each radiation detection device further comprises a select transistor electrically connected between the at least one pad of the second set of conductive pads and the read transistor. In another example of the fourth aspect or the examples above, the readout circuitry is configured to activate the select transistor to selectively read a charge state of the at least one pad through the read transistor.

In a fifth aspect, a radiation detection device includes a substrate, a sensing pad formed over the substrate, and a dielectric material separating the sensing pad from the substrate. A transistor is formed in the substrate and comprises a floating gate electrically connected to the sensing pad. The transistor further includes a control gate formed over the floating gate and separated from the floating gate by an additional dielectric layer. The transistor is operable to detect an influence of radiation when a read voltage is applied to the control gate.

In an example of the fifth aspect or the examples above, the dielectric material comprises a radiation reactive material. In another example of the fifth aspect or the examples above, the radiation reactive material comprises a component selected from the group consisting of boron-10, lithium-6, cadmium-113, gadolinium-157, and uranium-235. In a further example of the fifth aspect or the examples above, the radiation reactive material comprises the component in an enriched amount. In an additional example of the fifth aspect or the examples above, the radiation reactive material comprises an oxide of boron.

In another example of the fifth aspect or the examples above, the sensing pad has a surface area in a range of 0.5 μm² to 6 μm². In a further example of the fifth aspect or the examples above, the surface area of the sensing pad is at least ten times a surface area of the floating gate of the transistor.

In an additional example of the fifth aspect or the examples above, the sensing pad is formed of polysilicon. In another example of the fifth aspect or the examples above, the sensing pad has a thickness in a range of 50 nm to 350 nm.

In a further example of the fifth aspect or the examples above, the device further comprises a select transistor electrically connected between the sensing pad and the floating gate of the transistor. In an additional example of the fifth aspect or the examples above, the device further includes a charge transistor electrically connected to the sensing pad.

In another example of the fifth aspect or the examples above, the transistor further comprises a source region and a drain region formed in the substrate. In a further example of the fifth aspect or the examples above, the source region and the drain region are formed of a first conductivity type, and the substrate comprises a second conductivity type opposite to the first conductivity type.

In an additional example of the fifth aspect or the examples above, the device further comprises a tunnel dielectric layer formed between the substrate and the floating gate. In another example of the fifth aspect or the examples above, the tunnel dielectric layer comprises an oxide of silicon. In a further example of the fifth aspect or the examples above, the tunnel dielectric layer has a thickness in a range of 1 nm to 8 nm.

In a sixth aspect, a radiation detector array includes a substrate and a plurality of radiation detection devices formed over the substrate. Each radiation detection device comprises a first pad extending in a first direction and a second pad extending in a second direction perpendicular to the first direction. The second pad overlaps the first pad and is separated from it by a dielectric layer. Each radiation detection device further includes a transistor electrically connected to one of the first pad or the second pad, and an insulation material surrounds the first and second pads. The plurality of radiation detection devices are arranged in alternating layers with the first pads and second pads of adjacent layers oriented perpendicular to each other.

In an example of the sixth aspect or the examples above, the insulation layer comprises a radiation reactive material. In another example of the sixth aspect or the examples above, the radiation reactive material comprises a component selected from the group consisting of boron-10, lithium-6, cadmium-113, gadolinium-157, and uranium-235. In a further example of the sixth aspect or the examples above, the component is included in an enriched amount.

In an additional example of the sixth aspect or the examples above, the transistor comprises a floating gate electrically connected to one of the first pad or the second pad. In another example of the sixth aspect or the examples above, the transistor further comprises a control gate configured to receive a control voltage for reading a charge state of the floating gate.

In a further example of the sixth aspect or the examples above, the first pad and the second pad are formed of polysilicon. In an additional example of the sixth aspect or the examples above, the first pad and the second pad have a thickness in a range of 50 nm to 350 nm.

In another example of the sixth aspect or the examples above, the radiation detector array further comprises a select transistor electrically connected between one of the first pad or the second pad and the transistor. In a further example of the sixth aspect or the examples above, the array further includes a charge transistor electrically connected to one of the first pad or the second pad.

In an additional example of the sixth aspect or the examples above, the perpendicular orientation of the first pads and second pads in adjacent layers provides radiation detection coverage in multiple directions within the array.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A radiation detection device, comprising:
a first set of pads;
a second set of pads interlaced with the first set of pads;
an insulation layer separating the first set of pads from the second set of pads; and
a read transistor electrically connected to at least one pad of the second set of pads operable to detect an influence of radiation on the at least one pad.

2. The radiation detection device of claim 1, wherein the first set of pads is electrically connected to ground.

3. The radiation detection device of claim 1, wherein the first set of pads is electrically connected to a bias or reference voltage.

4. The radiation detection device of claim 1, wherein the first set of pads is electrically connected to a second transistor.

5. The radiation detection device of claim 1, wherein the insulation layer comprises a radiation reactive material.

6. The radiation detection device of claim 5, wherein the radiation reactive material comprises a component selected from the group consisting of boron-10, lithium-6, cadmium-113, gadolinium-157, and uranium-235.

7. The radiation detection device of claim 6, wherein the component of the radiation reactive material is present in an enriched amount.

8. The radiation detection device of claim 6, wherein the radiation reactive material comprises an oxide of boron.

9. The radiation detection device of claim 1, further comprising a select transistor electrically connected between the at least one pad of the second set of pads and the read transistor.

10. The radiation detection device of claim 1, further comprising a charge transistor electrically connected to at least one pad of the second set of pads.

11. The radiation detection device of claim 1, wherein the first set of pads and the second set of pads are arranged in alternating layers.

12. The radiation detection device of claim 1, wherein the first set of pads includes 2 to 10 pads disposed in separate layers.

13. The radiation detection device of claim 1, wherein the second set of pads includes 2 to 10 pads disposed in separate layers.

14. The radiation detection device of claim 13, wherein the alternating layers are formed in metal layers of a semiconductor chip.

15. The radiation detection device of claim 1, wherein the read transistor comprises a floating gate electrically connected to the at least one pad of the second set of conductive pads.

16. The radiation detection device of claim 15, wherein the read transistor further comprises a control gate configured to receive a control voltage for reading a charge state of the floating gate.

17. The radiation detection device of claim 1, wherein the first set of conductive pads and the second set of conductive pads are formed of polysilicon.

18. The radiation detection device of claim 1, wherein the first set of conductive pads and the second set of conductive pads have a thickness in a range of 10 nm to 500 nm.

19. The radiation detection device of claim 18, wherein the thickness is in a range of 50 nm to 350 nm.

20. The radiation detection device of claim 1, wherein a pad of the first set of pads is formed of doped polysilicon.

21-89. (canceled)
